(19) United States
(12) Patent Application Publication
(10) Pub. No.: US 2018/0303176 A1
(43) Pub. Date: Oct. 25, 2018

(54) PROTECTIVE GLOVE

(71) Applicant: RINGERS TECHNOLOGIES LLC, Houston, TX (US)

(72) Inventor: Hardy Lim, Houston, TX (US)

(21) Appl. No.: 15/821,500

(22) Filed: Nov. 22, 2017

Related U.S. Application Data
(63) Continuation-in-part of application No. 15/493,925, filed on Apr. 21, 2017.
Application No. 15/493,925 is a continuation of application No. 29/619,598, filed on Sep. 29, 2017.
Application No. 29/619,598 is a continuation of application No. 15/493,925, filed on Apr. 21, 2017.

(51) Int. Cl. A41D 19/015; G06F 3/01; A41D 19/00

(52) U.S. Cl. CPC A41D 19/01529; A41D 2600/20; G06F 3/014; A41D 19/01505; A41D 19/01523; A41D 19/0048

(57) ABSTRACT

Protective gloves are provided. At least one of the protective gloves can include a flame resistant glove body including a palm sleeve, a thumb sleeve, a trigger finger sleeve, and a plurality of finger sleeves extending distally from the palm sleeve. The trigger finger sleeve has a protective pad extending along a proximal back side of the trigger finger sleeve. The trigger finger sleeve also has an unprotected distal portion extending from a distal end of the protective pad to a distal end of the trigger finger sleeve. The finger sleeve further includes a protective member covering a first portion of a side of the trigger finger sleeve and including an indentation adjacent a second portion of the side of the trigger finger sleeve. Respective conductive tabs can be positioned on one or more sleeves to operate a touch screen while wearing a protective glove.

### CROSS-REFERENCE TO RELATED APPLICATION

This application is a continuation-in-part of U.S. patent application Ser. No. 15/493,925, filed Apr. 21, 2017, and a continuation of U.S. Design application Ser. No. 29/619,598, filed Sep. 29, 2017 which is a continuation of Ser. No. 15/493,925, filed on Apr. 21, 2017, the entireties of each of which are hereby incorporated by reference herein.

### BRIEF DESCRIPTION OF THE DRAWINGS

FIG. 1 illustrates a top view of a back side of a glove, according to one or more embodiments of the present disclosure.

FIG. 2 illustrates a bottom view of a palm side of a glove, according to one or more embodiments of the present disclosure.

FIG. 3A illustrates a side view of a phalangeal segment of a finger sleeve, according to one or more embodiments of the present disclosure.

FIG. 3B illustrates a section view along segment 3B-3B of FIG. 3A, featuring an example of internal structures of a finger sleeve, according to one or more embodiments of the present disclosure.

FIG. 3C illustrates a section view of an alternative construction of a distal finger sleeve, according to one or more embodiments of the present disclosure.

FIG. 4 illustrates a side view of a phalangeal segment of a finger sleeve, according to one or more embodiments of the present disclosure.

FIG. 5 illustrates a side view of a back side of a thumb sleeve featuring an example of protective padding, according to one or more embodiments of the present disclosure.

FIG. 6 illustrates a side view of a trigger finger sleeve, according to one or more embodiments of the present disclosure.

FIG. 7 illustrates a bottom view of a palm side of a glove, according to one or more embodiments of the present disclosure.

FIG. 8 illustrates a bottom view of a palm side of a glove, featuring an example of a seamless construction of a conductive tab and a loop pad attachment member having an attachment loop thereon, according to one or more embodiments of the present disclosure.

FIG. 9A illustrates a top perspective view of a back side of a glove, according to one or more embodiments of the present disclosure.

FIG. 9B illustrates a top view of a back side of the glove shown in FIG. 9A.

FIG. 10 illustrates a side view of the glove shown in FIGS. 9A and 9B.

FIG. 11 illustrates a bottom view of a palm side of the glove shown in FIG. 9, according to one or more embodiments of the present disclosure.

The foregoing drawings are a part of the disclosure and are incorporated into the present specification. The drawings illustrate examples of embodiments of the disclosure and in conjunction with the description and claims serve to explain, at least in part, various principles, elements, and/or aspects of the disclosure. Some embodiments of the disclosure are described more fully below with reference to the foregoing drawings. However, various elements of the disclosure can be implemented in many different forms and should not be construed as being limited to the implementations set forth herein. Like reference numbers refer to like, but not necessarily the same or identical, elements throughout.

### DETAILED DESCRIPTION

Touch screen technology can facilitate the operation of electronic devices, such as smartphones, watches, tablet computers, and the like. Workers in many industries wear protective gloves. For workers who wear gloves while using touch screens, significant amounts of time are wasted repeatedly removing and replacing gloves in order to use touch screens. Additionally, the risk of injury increases when gloves are removed to use a touch screen. These problems have led to the development of gloves that can be worn while operating touch screens.

In police and military work, conventional specialized protective gloves may allow officers to perform police job functions while minimizing the risk of injury. Police protective gloves feature a balance between protection and dexterity. Features of police protective gloves include the use of flame resistant material to protect from burns, protective padding in selected areas, and reduction of bulk in selected areas to facilitate tasks such as shooting a gun, applying handcuffs, driving, and the like. Drawbacks of conventional specialized police protective gloves include the inability to use such gloves to handle firearms and explosive devices and to operate touch screens while benefiting from the protective benefits and operability of police gloves.

The present disclosure recognizes and addresses at least the foregoing issues and, in at least some embodiments, provides protective gloves configured to protect a hand of a user while facilitating dexterity in police and/or military activities, such as firing a firearm, handling explosive devices, and/or operating a touch screen. A protective glove in accordance with this disclosure includes a flame resistant glove body configured to receive and enclose a hand of a user, the flame resistant glove body including a palm sleeve; a thumb sleeve extending from the palm sleeve; a trigger finger sleeve (e.g., an index finger sleeve) also extending distally from the palm sleeve and having a first length; and a plurality of finger sleeves extending distally from the palm sleeve. In some embodiment, the trigger finger sleeve has a first length and a protective pad assembly extending along a proximal back side of the trigger finger sleeve. The protective pad assembly can have a second length that is less than the first length. In addition, the trigger finger sleeve also can have a protective member covering a first portion of a side of the trigger finger sleeve and including an indentation (e.g., a V-shaped indentation, a U-shaped indentation, or another type of notch or recess) adjacent a second portion of the side of the trigger finger sleeve. The finger sleeve also can include an unprotected distal portion extending from a distal end of the protective pad to a distal end of the trigger finger sleeve to thereby permit or otherwise facilitate, for example firing a gun and/or handling an explosive device while wearing the glove. A conductive tab is positioned on one of the thumb sleeve, the trigger finger sleeve, or plurality of finger sleeves for use in operating a touch screen while wearing the glove. In addition or in some embodiments, the conductive tab is on the trigger finger sleeve. Further or in some embodiments, the plurality of finger sleeves includes a middle finger sleeve, and a conductive tab is on the middle finger sleeve. A conductive tab can be provided on the thumb sleeve, the conductive tab positioned for use in operating a touch screen.

In addition or in some embodiments, respective flame resistant padding assemblies extend along a back side of the palm sleeve, a back side of the thumb sleeve, and a back side of at least one (or, in one embodiment, each one) of the plurality of finger sleeves. The flame resistant padding can be sized and positioned to protect a hand of a user. A gauntlet sleeve can be provided, the gauntlet sleeve depending distally from the palm sleeve, towards an arm joined to the hand of the user. An elastic wrist band can be disposed between the palm sleeve and the gauntlet sleeve. The conductive tab can be polyurethane. The flame resistant glove body can include aramid fibers. The protective pad assembly and the padding can include thermopoly rubber. In some embodiments, the conductive tab is affixed to the sleeve via a seamless construction.

In embodiments, a protective glove in accordance with this disclosure includes a flame resistant glove body configured to receive and enclose a hand of a user, a palmar side of the flame resistant glove body including flame resistant leather, a back side of the flame resistant glove body including flame resistant fabric. The flame resistant glove body includes a palm sleeve, a thumb sleeve extending from the palm sleeve, a trigger finger sleeve (e.g., an index finger sleeve) extending distally from the palm sleeve, and a plurality of finger sleeves extending distally from the palm sleeve. The trigger finger sleeve has a first length and a protective pad assembly extending along a proximal back side of the trigger finger sleeve. As mentioned, the protective pad assembly can have a second length that is less than the first length. In addition, the trigger finger sleeve also can have a protective member covering a first portion of a side of the trigger finger sleeve and including an indentation (e.g., a V-shaped indentation, a U-shaped indentation, or another type of notch or recess) adjacent a second portion of the side of the trigger finger sleeve. The finger sleeve also can include an unprotected distal portion extending from a distal end of the protective pad to a distal end of the trigger finger sleeve to thereby permit or otherwise facilitate, for example, firing a gun and/or handling an explosive device while wearing the glove. A conductive tab can be positioned on one of the thumb sleeve, the trigger finger sleeve, or plurality of finger sleeves to operate an electronic device via a touch screen while wearing the glove. The conductive tab can be affixed over the flame resistant leather of the palmar side. The conductive tab can be affixed to the trigger finger sleeve. The plurality of finger sleeves can include a middle finger sleeve, and the conductive tab can be affixed to the middle finger sleeve. In addition or as an alternative, the conductive tab can be affixed to the thumb sleeve, where the conductive tab is positioned to operate or facilitate operating an electronic device via a touch screen. Respective flame resistant padding assemblies can extend along a back side of the palm sleeve, a back side of the thumb sleeve, and respective back sides of one or more of the plurality of finger sleeves. The respective flame resistant padding assemblies, individually or collectively, can be sized and positioned on the protective glove to protect the hand of the user. In addition or in other embodiments, a gauntlet sleeve can depend distally from the palm sleeve, towards an arm joined to the hand of the user. An elastic wrist band can be disposed between the palm sleeve and the gauntlet sleeve. The conductive tab can be formed, for example, from polyurethane. The flame resistant glove body can include aramid fibers. The protective pad assembly and each one (or, in some embodiments, at least one) of the respective flame resistant padding assemblies can include thermopoly rubber, for example. In some embodiments, the conductive tab is affixed to a sleeve of the protective glove via a seamless construction.

In embodiments, a protective glove in accordance with this disclosure includes a flame resistant glove body configured to receive and enclose a hand of a user. The flame resistant glove body includes a palm sleeve, a thumb sleeve extending from the palm sleeve, a trigger finger sleeve (e.g., an index finger sleeve) extending distally from the palm sleeve, and a plurality of finger sleeves extending distally from the palm sleeve. The plurality of finger sleeves can include a middle finger sleeve adjacent to the trigger finger sleeve. The trigger finger sleeve can have a first length and a protective pad assembly extending along a proximal back side of the trigger finger sleeve. Similar to other embodiments, the protective pad assembly can have a second length that is less than the first length. In addition, the trigger finger sleeve also can have a protective member covering a first portion of a side of the trigger finger sleeve and including an indentation (e.g., a V-shaped indentation, a U-shaped indentation, or another type of notch or recess) adjacent a second portion of the side of the trigger finger sleeve. The trigger finger sleeve also can include an unprotected distal portion extending from a distal end of the protective pad assembly to a distal end of the trigger finger sleeve, thereby permitting or otherwise facilitating, for example, firing a gun and/or handling an explosive device while wearing the glove. In one embodiment, a conductive tab is positioned on the middle finger sleeve to operate or facilitate operating an electronic device via a touch screen while wearing the glove. The conductive tab can be affixed to the middle finger sleeve via a seamless construction. The seamless construction can include, for example, an inside seam situated on an interior of the glove between a lower end of the conductive tab and the flame resistant leather such that there is no exteriorly exposed seam between conductive tab and the flame resistant leather. In some embodiments, an interior side of the conductive tab is underlined with the flame resistant leather for protection of a user. In some embodiments, an interior side of the conductive tab is unlined for improved feel through the conductive tab and a fingertip of a user.

In addition or in other embodiments, respective flame resistant padding assemblies can extend along a back side of the palm sleeve, a back side of the thumb sleeve, and respective back sides of the plurality of finger sleeves. One or more of the respective flame resistant padding assemblies can be sized and positioned to protect a hand of a user. A gauntlet sleeve can depend distally from the palm sleeve, towards an arm joined to the hand of the user. An elastic wrist band can be disposed between the palm sleeve and the gauntlet sleeve. The conductive tab can be formed from polyurethane. The flame resistant glove body can include aramid fibers. The protective pad and the padding can include thermopoly rubber.

Gloves in accordance with embodiments of this disclosure can be provided as a pair, with a first one of the pair of gloves configured for a right hand and a second one of the pair of gloves configured for a left hand, such that the pair of gloves is configured for use in, for example, firing a gun and operating a touch screen with both a right and a left hand.

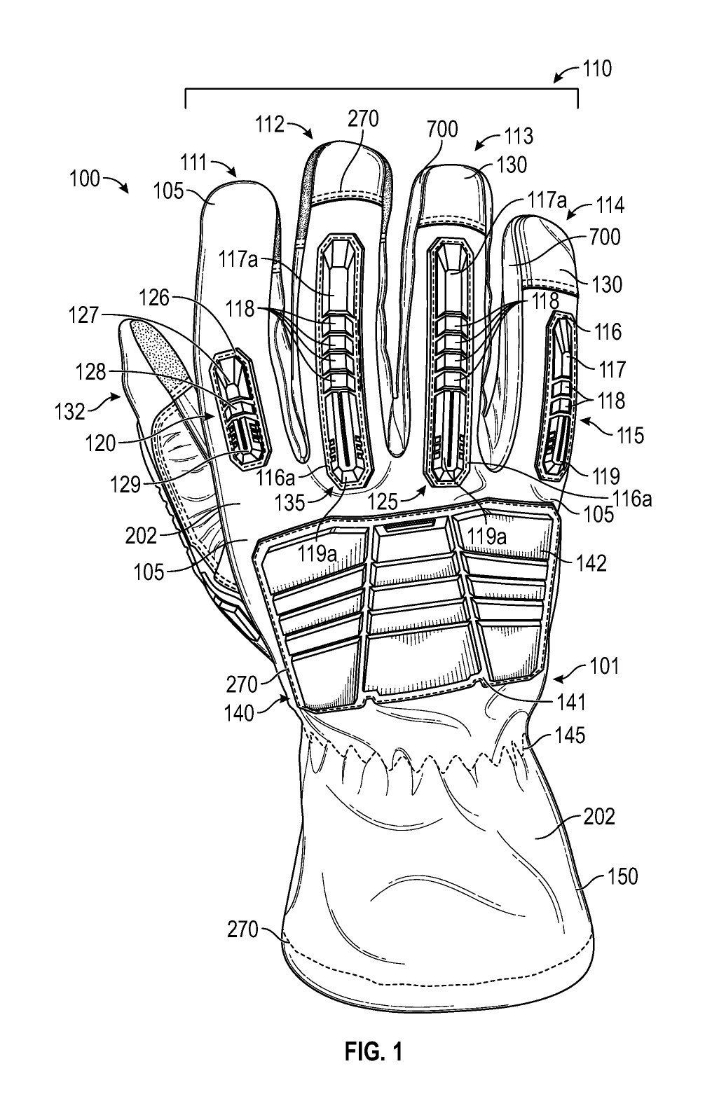

As illustrated in FIGS. 1, 2, 7. and 8, embodiments of the present disclosure include a protective glove 100 that is configured to protect a hand of a user while facilitating dexterity in police and/or military activities, such as firing a gun, handling explosive devices, and/or operating a touch screen. Although the protective glove 100 is a right-handed glove, the disclosure is not so limited and elements of the protective glove 100 also can be implemented in a left-handed glove. The protective glove 100 includes a flame resistant glove body 101 configured to receive and enclose the hand of the user. The flame resistant glove body 101 includes a palm sleeve 103. A thumb sleeve 132 and a trigger finger sleeve 111 extend distally from the palm sleeve 103. A plurality of finger sleeves, including finger sleeve 112, finger sleeve 113, and finger sleeve 114, also extend distally from the palm sleeve 103.

The trigger finger sleeve 111 includes a protective pad assembly 120 extending along a proximal back side of trigger finger sleeve 111. The trigger finger sleeve 111 also includes an unprotected distal portion extending from a distal end of the protective pad assembly 120 to a distal end of the trigger finger sleeve 111. This configuration of the protective pad assembly 120 can permit or otherwise facilitate, for example, firing a gun and/or handling an explosive device while wearing the protective glove 100. It is noted that while a correspondence between the trigger finger sleeve 111 and an index finger of user of the protective glove 100 may be conveyed in FIG. 1 and other annexed drawings, such a correspondence is simply illustrative and the disclosure is not limited in that respect. In some embodiments, a trigger finger sleeve may correspond to a finger other than the index finger, depending on the anatomy of the user of the protective glove 100.

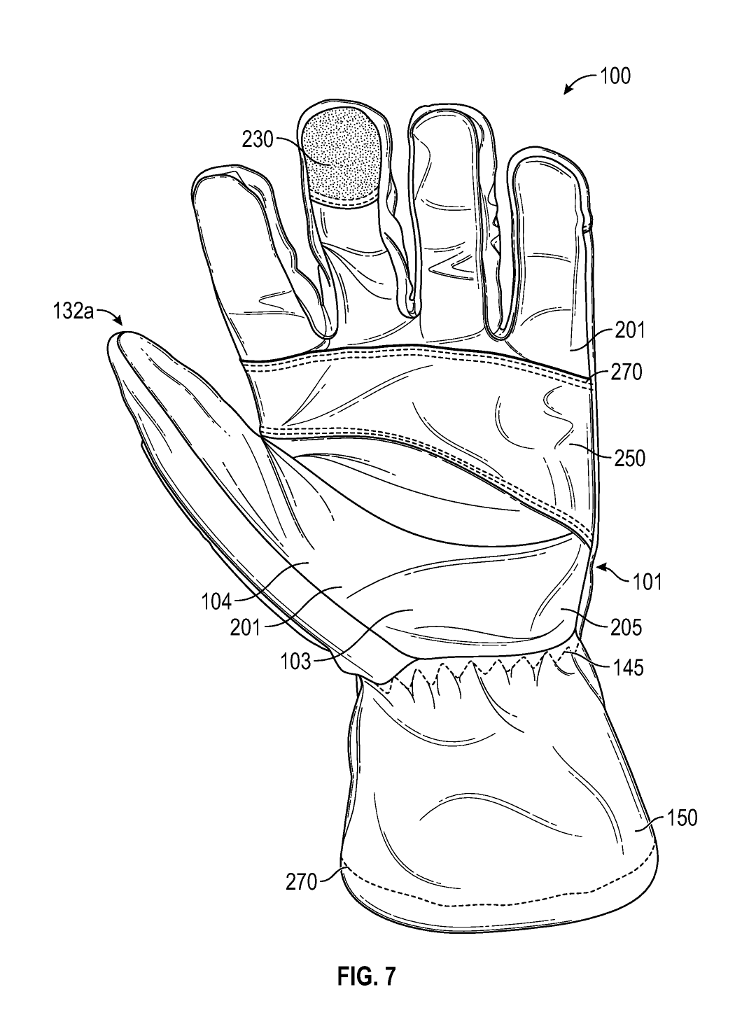

In an alternative embodiment of the trigger finger sleeve 111, as is shown in FIG. 6, for example, glove bottom 205 may be configured to extend from the palmar surface, around a side of the trigger finger sleeve 111 to form protective member 500. As is shown in FIG. 6, protective member 500 extends along the side of the trigger finger sleeve 111 nearest the thumb. Configurations as those illustrated in FIG. 6 may provide law enforcement and/or military personnel additional protection along the trigger finger sleeve 111 during standard activities, such as the use of firearms, explosive devices, or other weaponry. A double layer of stitching 270, as is shown in FIG. 6, can be included to provide additional reinforcement.

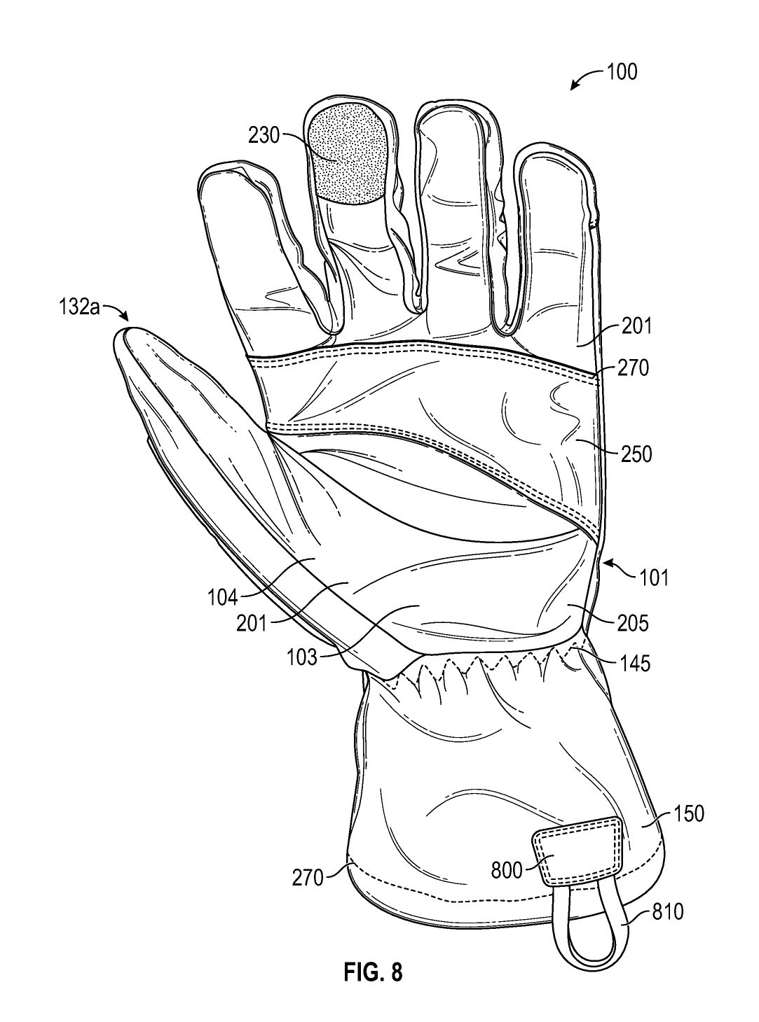

With further reference to FIG. 1, At least one conductive tab 230 is provided to operate or otherwise facilitate operating an electronic device via a touch screen while wearing the protective glove 100. In some embodiments, a conductive tab 230 can be provided on the trigger finger sleeve 111, on the thumb sleeve 132, on a middle finger sleeve 112, or on two or more of the foregoing sleeves. In another embodiment, as is illustrated in FIG. 7, conductive tab 230 may be disposed exclusively on the middle finger sleeve 112. Conductive tab(s) can be positioned on a palm side of a tip of the finger sleeve 111, finger sleeve 112, thumb sleeve 132, and/or thumb sleeve 132a.

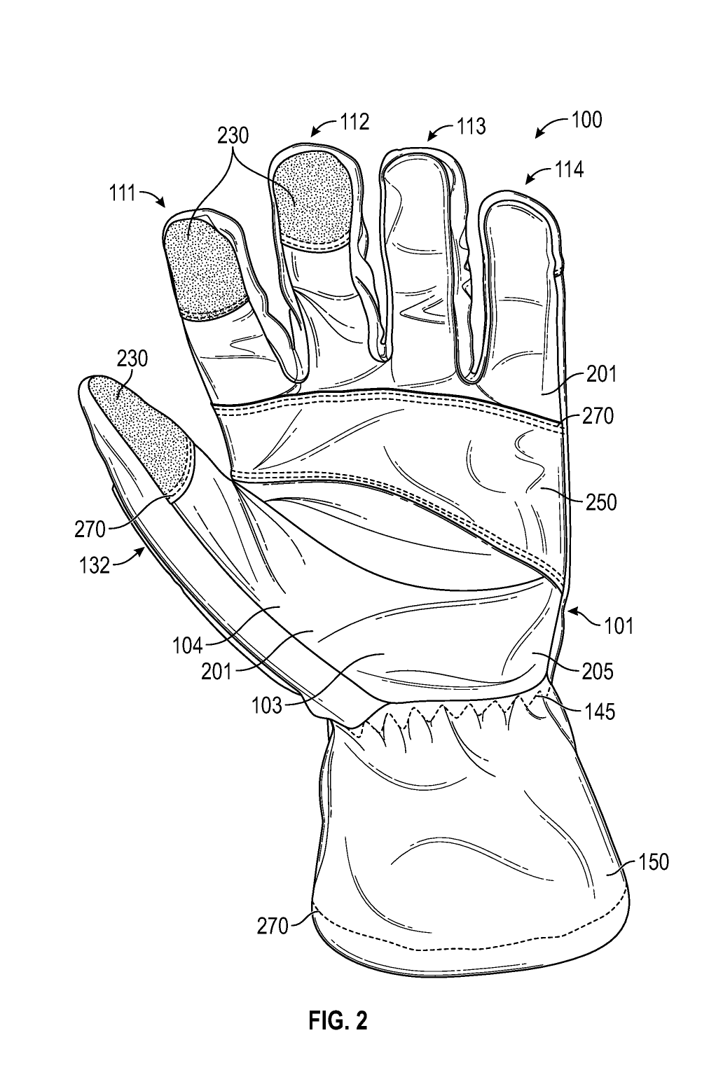

With further reference to FIG. 1, the protective glove 100 can include a phalangeal protective padding assembly 115, a phalangeal protective padding assembly 125, a phalangeal protective padding assembly 135, and a metacarpal protective padding assembly 140 for additional protection from fire, heat, blows, abrasion, and the like. To that end, in some embodiments, each one (or, in other embodiments, at least one) of the phalangeal protective padding assemblies 115, 125, 135, and the metacarpal protective padding assembly 140 can be embodied in or can include a flame resistant material and/or other materials configured to withstand mechanical shocks or vibration without being damaged. Accordingly, in such embodiments, one or more of the phalangeal protective padding assemblies 115, 125, 135, and metacarpal protective padding assembly 140 can be referred to as flame resistant protective padding assemblies. As is illustrated in FIG. 1, phalangeal protective padding assembly 115 can extend along a back side of finger sleeve 114; the phalangeal protective padding assembly 125 can extend along a back side of finger sleeve 113; the phalangeal protective padding assembly 135 can extend along a back side of finger sleeve 112; and the metacarpal protective padding assembly 140 can extend along a back side of the palm sleeve 103 (see, e.g., FIG. 2 for reference). As is shown in FIG. 1, the protective glove 100 also can include one or more protective assemblies extending along a back side of the thumb sleeve 132. The plurality of finger sleeves 112, 113, 114 may be joined one to the other and to the glove back 105 and glove bottom 205 by an interdigital section 700 of material, e.g., leather. Each one (or, in some embodiments, at least one) of the phalangeal protective padding assembly 115, phalangeal protective padding assembly 125, phalangeal protective padding assembly 135, and metacarpal protective padding assembly 140 can be sized and positioned to protect the hand of a user. Similarly, as is described herein, one or more padding assemblies attached to the thumb sleeve 132 also can be sized and/or positioned to protect the hand of the user.

The protective glove 100 can be provided with a gauntlet sleeve 150 for additional protection. The gauntlet sleeve 150 depends distally from the palm sleeve 103. In some embodiments, an elastic wrist band 145 can be disposed between the palm sleeve 103 and the gauntlet sleeve 150.

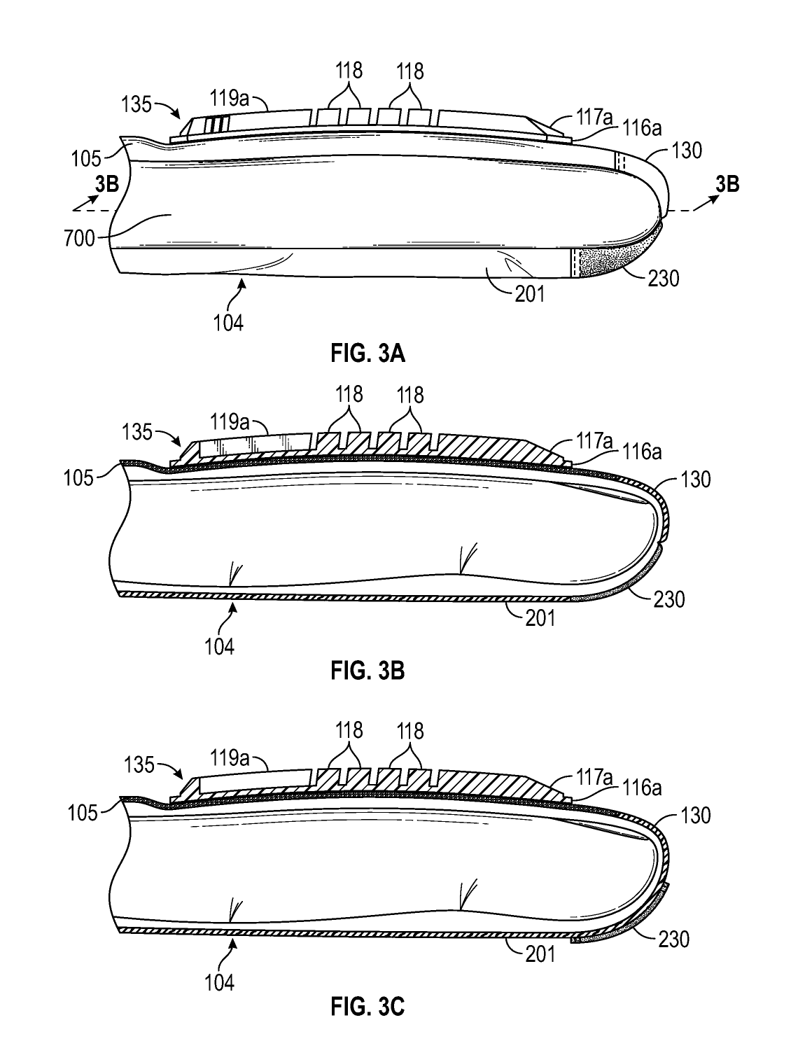

In one embodiment, a palmar side 104 of the glove body 101 includes flame resistant leather, and a back side 105 of the glove body 101 comprises a flame resistant fabric 202. As is shown in FIG. 3C, the conductive tab 230 can be affixed over the flame resistant leather 201 of the palmar side 104, yet still operate a touch pad through the flame resistant leather 201.

The conductive tab 230 includes a material, such as polyurethane, that conducts charge from a user to a touch screen. The flame resistant fabric 202 can comprise aramid fibers, such as KEVLAR® fibers. Each one (or, in some embodiments, at least one) of the protective pad assembly 120, the phalangeal protective padding assembly 115, phalangeal protective padding assembly 125, phalangeal protective padding assembly 135, and metacarpal protective padding assembly 140 can include thermopoly rubber. Similarly, in some embodiments, one or more padding assemblies attached to the thumb sleeve 132 also can include thermopoly rubber.

Protective gloves 100 in accordance with embodiments of this disclosure can be provided as a pair having a right-hand protective glove 100 and a left-hand protective glove 100, such that the pair of gloves is configured for use in, for example, firing a gun and operating a touch screen with both a right and a left hand.

With reference further reference to the drawing, FIG. 1 illustrates a back, or dorsal, view of an example of a protective glove 100. The protective glove 100 has a flame resistant glove body 101 configured to receive and enclose a hand of a user. A back side 105 of the glove is made of a durable, flexible, flame resistant material, such as aramid fabric (available commercially as KEVLAR® fabric, for example).

FIG. 2 illustrates a front, or palmar, view of a protective glove 100, in accordance with one or more embodiments of this disclosure. A palmar side 104 of the protective glove 100 can be made of a durable, flexible, flame resistant material, such as flame resistant (treated) leather 201. The leather 201 may be goat leather.

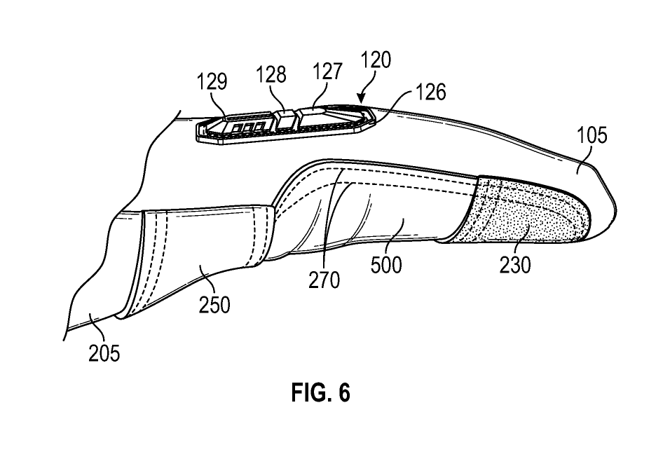

The glove body 101 includes a palm sleeve 103 configured to receive and protect a palm area of a user. A thumb sleeve 132 extends from the palm sleeve 103, generally along a medial and palmar side of the glove body 101. The thumb sleeve 132 is configured to receive and protect a thumb of a user. FIG. 5 illustrates a top view of the thumb sleeve 132 configured to include a first protective assembly 180 and a second protective assembly 195. In one aspect, the first protective assembly 180 may include protective members covering both the thumb phalange and thumb metacarpal of a user. In addition or in other aspects, as is illustrated in FIG. 5 the first protective member 180 can include a thumb base member 181, a distal phalangeal protective padding member 182, a plurality of medial phalangeal protective padding members 183, a proximal phalangeal protective padding member 184, and a plurality of metacarpal protective padding members 190. In addition, as is further illustrated in FIG. 5, the second protective assembly 195 may be included between the first protective member 180 and the palm sleeve 103 in order to provide additional protection to the hand of the user.

As is shown in FIG. 1, a plurality of individual phalangeal portions or finger sleeve portions 110 extend distally from the palm sleeve 103. The finger sleeve portions 110 include a trigger finger sleeve 111 and a plurality of finger sleeves 112, 113, 114. The plurality of finger sleeves 112, 113, 114 can include a middle finger sleeve 112, a ring finger sleeve 113, and a pinky finger sleeve 114. It is noted that some or all of the plurality of finger sleeves 112, 113, 114 can be joined together into a single sleeve, in the manner of a mitten.

In one aspect, the protective glove 100 permits or otherwise facilitates the operation of a touch screen while wearing the protective glove 100. As is shown in FIGS. 2-4, this functionality can be provided by providing at least one conductive tab 230. A conductive tab 230 can be provided on the trigger finger sleeve 111, on the thumb sleeve 132, on a middle finger sleeve 112, or on two or more of the foregoing sleeves. As is shown in FIG. 2, the conductive tabs are positioned for use, for example, in operating a touch screen, such as by placement on a palm side of a tip of the finger sleeve 111, finger sleeve 112 and thumb sleeve 132.

As is shown in FIG. 7, in some embodiments, the conductive tab 230 can be disposed exclusively on one of the finger sleeves, such as on only the middle finger sleeve 112. For instance, police, military, and/or other users of the protective glove 100 in accordance with the embodiment depicted in FIG. 7 can manipulate touch screens using the tip of the middle finger. In addition, by not providing conductive tab 230 touchscreen material on the index fingertip and thumb tip, users of the protective glove 100 can have better tactile feel and dexterity in the thumb and index finger for use and manipulation of weapons, triggers, switches, levers, other types of instruments, and so forth. Thus, in one aspect, multitasking is further facilitated by the protective glove 100 shown in FIG. 7, while still providing the protective features described herein.

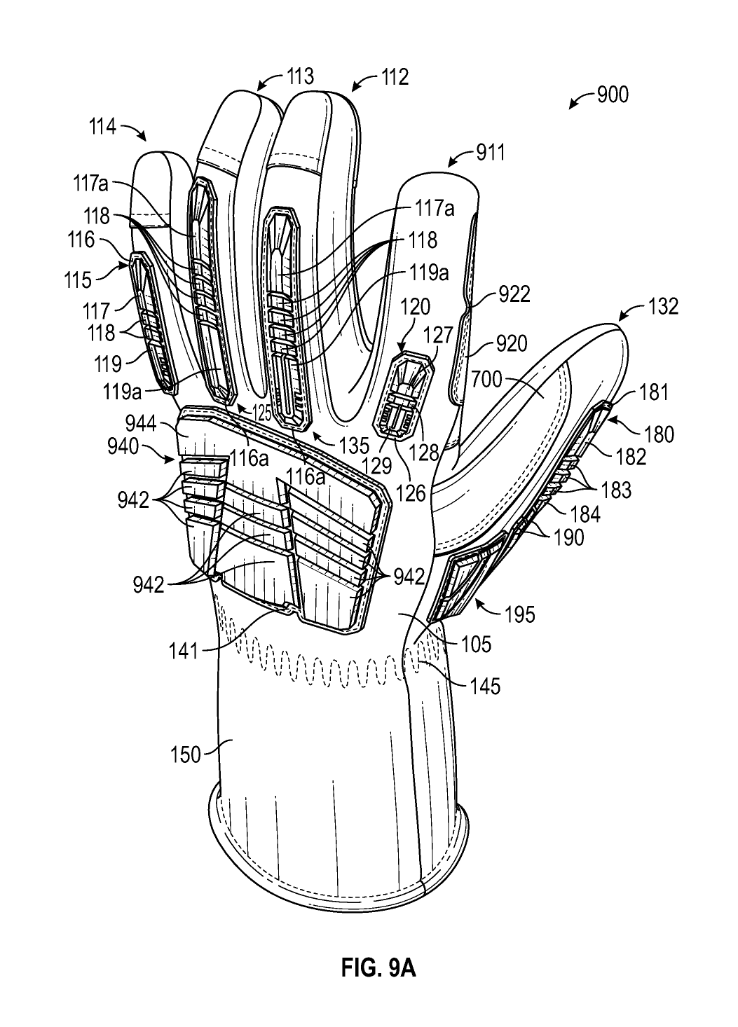

FIG. 8 illustrates a protective glove 100 having an alternative single conductive tab 230 featuring a seamless construction of the touch screen material 230. In an embodiment of the protective glove 100 illustrated in FIG. 8, inside seam construction has been used to sew the touchscreen material 230 to the tip of middle finger sleeve 112. The stitching between the conductive tab 230 and the flame resistant leather 201 material is located on the interior or inside of protective glove 100. The interior stitching includes an inside seam situated on an interior of the protective glove 100 between a lower end of the conductive tab 230 and the flame resistant leather 201 such that there is no exteriorly exposed seam between conductive tab 230 and the flame resistant leather 201. A seamless conductive tab 230 can be used on any of the finger sleeves 111, 112, 113, 114 or thumb sleeve 132a. Further or in some embodiments, flame resistant leather 201 can be provided under the interior side of conductive tab 230, as is illustrated in FIG. 3C, for protection. Alternatively, no leather can be provided on the interior side of the conductive tab 230, as is illustrated in FIG. 3B, for better feel through the conductive tab 230 and fingertip.

As is also illustrated in FIG. 8, in one embodiment, the protective glove 100 includes a loop-pad attachment member 800 featuring an attachment loop 810 affixed thereto. The loop-pad 800 can be affixed (by stitching, for example) to the palmar side 103 of the gauntlet cuff 150 or to other locations on the glove body 101. The attachment loop 810 extends from the protective glove 100 so as to provide an efficient storage option when a user removes the protective glove 100. The user can readily attach the protective glove 100 via the attachment loop 810 to other structures, such as clothing, equipment, and the like. For example, the attachment loop 810 can be selectively attached to a utility belt, to gear or structures worn on the user's body, to motorcycle handle bars, or to structures in a squad car or another type of vehicle, thereby temporarily securing the glove or pair of gloves 100 in a handy and readily accessible location for use.

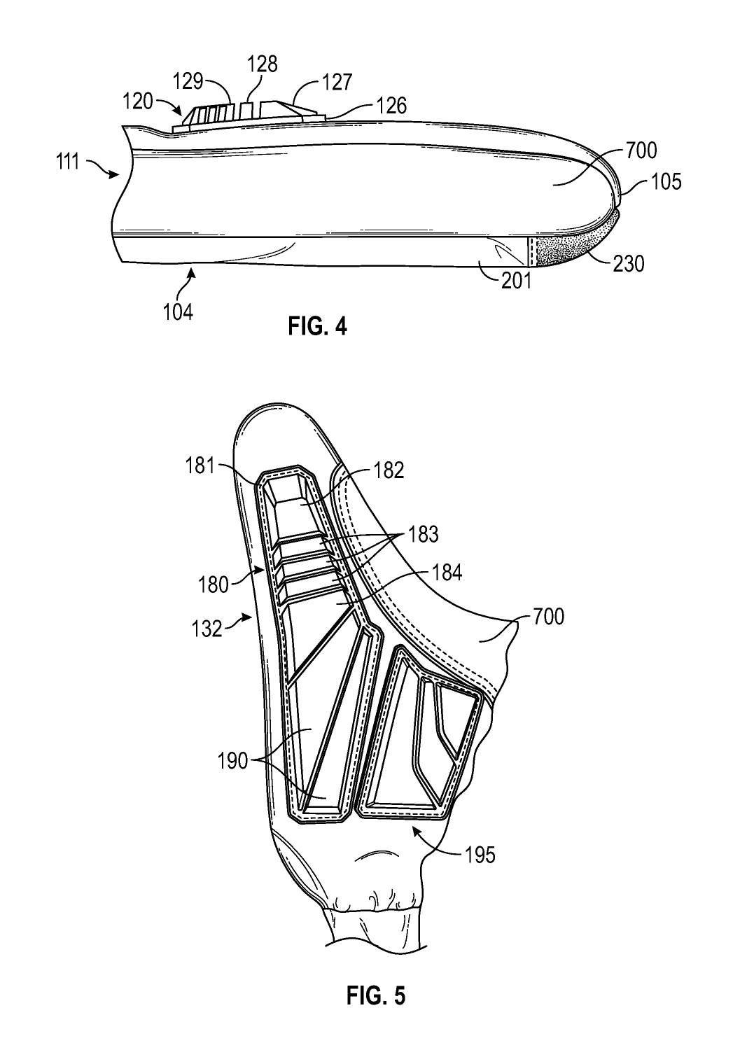

In an embodiment illustrated in FIGS. 1, 2, 3B and 4, the protective glove 100 can include a trigger finger sleeve 111 that is configured for use in operating a touch screen, handling an explosive device, and/or firing a gun while wearing the protective glove 100. A distal palmar side of the trigger finger sleeve 111 can be provided with a distal conductive tab 230 for use in operating a touch screen. As is shown in FIG. 4, the ability to effectively fire a gun or handle an explosive device can be provided by having a phalangeal protective padding assembly or protective pad assembly 120 that is truncated or otherwise shortened relative to a length of the trigger finger sleeve 111. The protective pad assembly 120 can be attached to the trigger finger sleeve 111 such that a distal portion of the trigger finger sleeve 111 is unimpeded by or otherwise decoupled from the protective pad assembly 120. In embodiments illustrated in FIGS. 1 and 4, the trigger finger sleeve 111 has a protective pad assembly 120 extending along a proximal back side thereof. The trigger finger sleeve 111 has an unprotected distal portion extending from a distal end of the protective pad assembly 120 to a distal end of the trigger finger sleeve 111. This configuration permits or otherwise facilitates firing a gun or handling an explosive device while wearing the protective glove 100. As is illustrated in FIG. 4, the protective pad assembly 120 includes a base member 126 affixed, by stitching 270, for example, to a proximal back portion of the trigger finger sleeve 111. A plurality of elevated padding members extend from the base member 126, such as a distal elevated padding member 127, at least one medial elevated padding member 128, and a proximal elevated padding member 129. Grooves between some or all of the elevated padding members 127, 128, 129 can permit or otherwise facilitate flexible movement of the trigger finger sleeve 111. The size and position of the truncated protective pad assembly 120 can permit or otherwise facilitate unimpeded use of the phalange in space restricted areas, such as the space between a weapon trigger and the trigger guard.

In some embodiments, as is shown in FIGS. 1 and 3, the phalangeal protective padding assembly 115 includes a base member 116 along a lower side of the phalangeal protective padding assembly 115. The base member 116 is affixed, by stitching 270, for example, to the glove body 101. A plurality of elevated padding members 117, 118, 119 extend from the base member 116. Similarly, each one (or, in some embodiments, at least one) of the phalangeal protective padding assembly 125 and the phalangeal protective padding assembly 135 also can include a base member 116a abutting against a back side of a respective finger sleeve. In one example, the base member 116a is affixed, by stitching 270, for example, to the glove body 101. In addition, each one (or, in some embodiments, at least one) of the phalangeal protective padding assembly 125 and the phalangeal protective padding assembly 135 also can include a plurality of elevated padding members 117a, 118, 119a that extend from the base member 116a. More specifically, as is shown in FIGS. 3A and 3B, such elevated padding members can include a distal elevated padding member 117a; a group of medial elevated padding members, including a first medial elevated padding member 118, a second medial elevated padding member 118, a third medial elevated padding member 118, a fourth medial elevated padding member 118; and a proximal elevated padding member 119a.

With further reference to FIG. 1, in some embodiments, the protective glove 100 may include a metacarpal protective padding assembly 140 positioned to protect the back of a hand of a user. In the embodiment of FIG. 1, the metacarpal protective padding assembly 140 includes a metacarpal base member 141 along a lower side of the metacarpal protective assembly 140. The metacarpal base member 141 is affixed, such as by stitching 270, to the glove body 101. Metacarpal base member 141 may extend across the metacarpal region of a hand, covering the region spanning metacarpals two through five, for example. In some embodiments, metacarpal protective padding assembly 140 may include one or more metacarpal elevated padded members 142 extending from the base member 141. As is further illustrated in FIG. 1, the metacarpal protective padding assembly 140 may include a plurality of metacarpal elevated padded members 142. In one aspect, the metacarpal elevated padded members 142 can be placed separated from one another by grooves, for example, in order to improve mobility and/or flexibility of metacarpal protective padding assembly 140. Alternatively, in some embodiments, the metacarpal protective padding assembly 140 can include a plurality of smaller protective members that are separately affixed to the glove body 101. In some embodiments, the phalangeal protective padding assembly 115, phalangeal protective padding assembly 120, phalangeal protective padding assembly 125, phalangeal protective padding assembly 135, and metacarpal protective padding assembly 140 may be flame resistant, and may be solid, hollow, air-filled or gas-filled, and/or can include additional material, such as impact resistant material or anti-vibrational material.

As is shown in FIG. 1, each one (or, in some embodiments, at least one) of the individual phalangeal portions 110 may include one or more distal-tip phalangeal protective members 130 on the back side of the finger sleeves of the protective glove 100. In the embodiment of FIG. 1, the distal-tip phalangeal protective members 130 can be provided on the middle finger sleeve 112, the ring finger sleeve 113, and the pinky finger sleeve 114. The protective members may be reinforced with bonding material or stitching 270 to strengthen attachment.

As shown in FIGS. 1-2, embodiments of the protective glove 100 may include gauntlet cuff 150 extending from a distal end of the palm sleeve 103. Moreover, in certain embodiments, gauntlet cuff 150 may include an elastic band 145 circumnavigating the wrist. The elastic band 145 secures the glove body 101 to the hand and restricts entry of unwanted environmental contaminates such as dust, dirt and water by restricting or closing off access to the inside of the protective glove 100.

As shown in FIG. 2, embodiments of protective glove 100 may include at least one ventral or palmar protective member 250 on the palm sleeve 103. The palmar protective member 250 provides durability by resisting abrasion, and also provides a better grip on devices such as pistol handles. The palmar protective member 250 may traverse the ventral portion of the palm sleeve 103. The palmar protective member 250 may be formed from a variety of durable, flexible materials. The palmer protective member 250 may be formed from leather, such as goat-leather, and may be flame resistant.

The various components that form the protective glove 100 may be joined together to form a single unit, for example, by a bonding material. In some embodiments, the bonding material may be embodied in or may include natural or synthetic material. In addition or in other embodiments, the bonding material may be embodied in or may include glue, adhesive, stitching, a combination thereof, or the like. As is illustrated in FIGS. 1 and 2, a protective glove 100 in accordance with one or more embodiments of this disclosure can include numerous features joined together by stitching two or more pieces together with stitches 270. Material used for stitching 270 may be natural or synthetic. In some embodiments, natural materials may include at least one naturally derived fiber or cat-gut. In some embodiments, synthetic materials for stitching 270 may include synthetic polymers, e.g., nylon or nylon-like polymers. In addition or in some embodiments, synthetic materials for stitching 270 may include aromatic polyamide. Non-limiting examples of aromatic polyamides suitable for stitching 270 may include may include aramid or para-aramid.

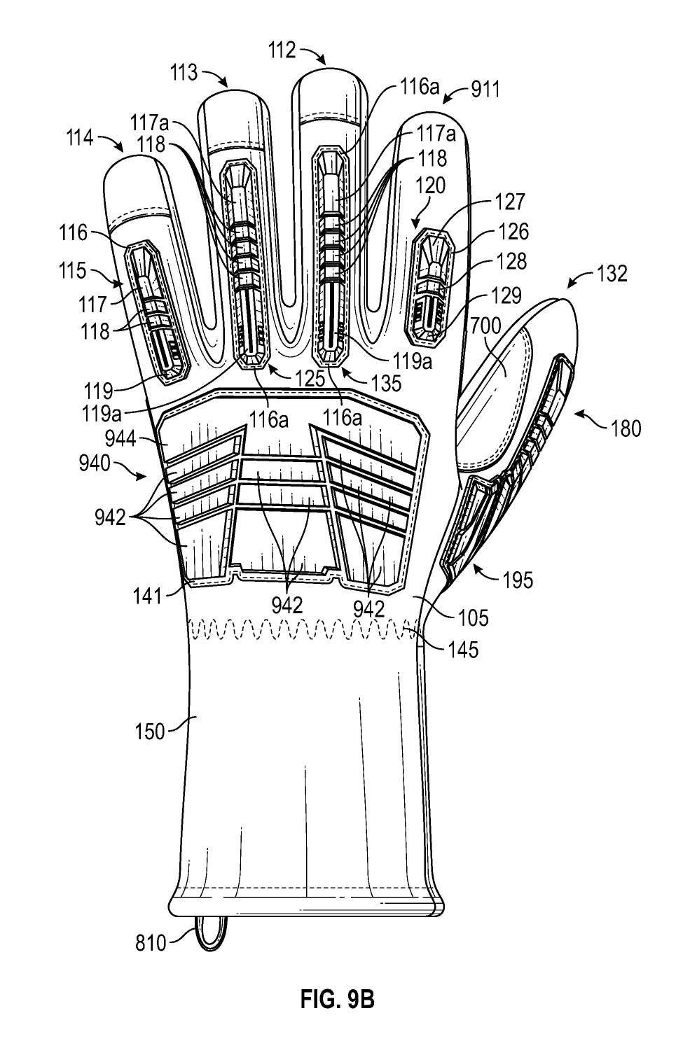

FIG. 9A illustrates a top perspective view of a back side of a protective glove 900 in accordance with one or more embodiments of the disclosure. Although the protective glove 900 is a left-hand glove, the disclosure is not so limited and elements of the protective glove 900 also can be implemented in a right-hand glove. Similar to other protective gloves of this disclosure, the protective glove 900 includes a trigger finger sleeve 911, a thumb sleeve 134, and a plurality of finger sleeves including finger sleeve 112, finger sleeve 113, and finger sleeve 114. The protective glove 900 includes several elements of others protective gloves described herein, including the phalangeal protective padding assembly 120. As described herein, and as is shown in FIGS. 9A and 9B, the phalangeal protective padding assembly 120 is truncated or otherwise shortened relative to a length of the trigger finger sleeve 911. Thus, in one aspect, a length of the phalangeal protective padding assembly 120 is less than the length of the trigger finger sleeve 911. As is shown in FIGS. 9A and 9B, the phalangeal protective padding assembly 120 also is truncated or otherwise shortened relative to each one of phalangeal protective padding assembly 115, phalangeal protective padding assembly 125, and phalangeal protective padding assembly 135.

In addition, the finger sleeve 911 includes a protective member 960—such as a protective layer or a protective pad—that covers at least a side portion of the trigger finger sleeve 911 nearest the thumb. The protective member 920 can be attached to the trigger finger sleeve 911 by means of one or more layers of stitching 270 and/or adhesives, for example. The protective member 960 can include an indentation 922 (e.g., a V-shaped indentation, a U-shaped indentation, or another type of notch or recess) in an edge portion near the proximal back side of the trigger finger sleeve. In one aspect, the shortened structure of the phalangeal protective padding assembly 120 in combination with the indentation in the protective member 920 can facilitate the flexure of the trigger finger sleeve 911, making the flexural motion of the trigger finger sleeve 911 more efficient and/or precise than in gloves without such an indentation.

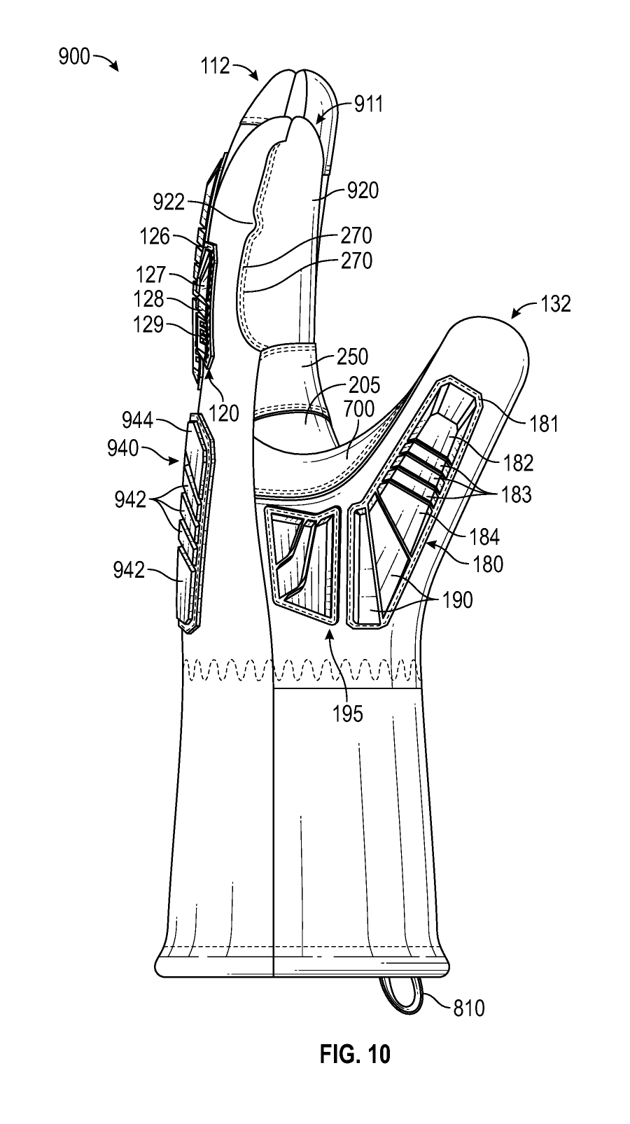

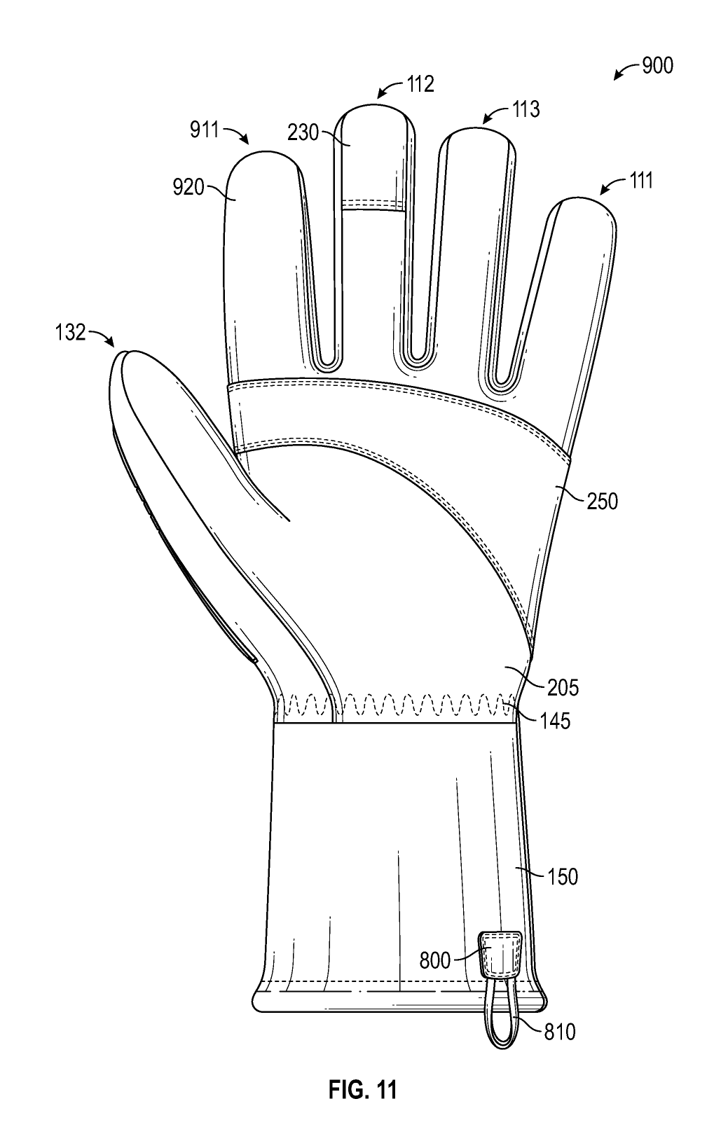

As is illustrated in FIG. 10 and FIG. 11, the protective member 920 can cover the entirety of the front (or palmar) side of the trigger finger sleeve 911, and is integral to the glove bottom 205. The structure of the palmar side of the protective glove 900 is similar to that of the protective glove 100 shown in FIG. 8. It is noted that while a correspondence between the trigger finger sleeve 911 and an index finger of user of the protective glove 900 may be conveyed in FIGS. 9A, 9B, 10, and 11, such a correspondence is simply illustrative and the disclosure is not limited in that respect. In some embodiments, a trigger finger sleeve may correspond to a finger other the index finger, depending on the anatomy of the user of the protective glove 900.

With further reference to FIG. 9A, similar to other protective gloves of this disclosure, the protective glove 900 includes a metacarpal protective padding assembly 940 arranged to protect the back of a hand of a user. The metacarpal protective padding assembly 940 includes the metacarpal base member 141. As described herein, the metacarpal base member 141 is affixed, such as by stitching, to the glove body 101 and abuts a surface of the glove back 105. In some embodiments, metacarpal protective assembly 140 may include a group of metacarpal elevated padding members 942 protruding or otherwise extending from the metacarpal base member 141. In one aspect, the group of metacarpal elevated padding members 942 can be placed separated from one another by grooves, for example, in order to improve mobility and/or flexibility of metacarpal protective padding assembly 940. Each one (or, in some embodiments, at least one) of the metacarpal elevated padding members 942 may be flame resistant, and may be solid, hollow, air-filled or gas-filled, and/or can include additional material, such as impact resistant material or anti-vibrational material. Accordingly, in at least some embodiments, the metacarpal protective padding assembly 940 can embody or otherwise constitute flame resistant padding or a flame resistant padding assembly.

The metacarpal protective padding assembly 940 also can include a metacarpal elevated padding member 944 affixed to the metacarpal base member 141. The metacarpal elevated padding member 944 resembles a T-shaped structure and includes (i) a first section extending between a first peripheral portion and a second peripheral portion of metacarpal base member 141 and (ii) a second section substantially perpendicular to the first section. As is illustrated in FIG. 9A, the first section is adjacent to a third peripheral portion of the metacarpal base member 141 and to two members of the metacarpal protective padding assembly 940. The second section is adjacent to such two members.

Compared to the separated arrangement of members 142 in the protective glove 100, the extended non-grooved structure of the metacarpal elevated padding member 944 can provide improved stability during use of the protective glove 900. As such, in some aspects, the metacarpal protective padding assembly 940 can provide protection of a hand of user while further facilitating the discharge of a firearm.

In some embodiments, at least one of the members of the metacarpal protective padding assembly 940 may be flame resistant, and may be solid, hollow, air-filled or gas-filled, and/or can include additional material, such as impact resistant material or anti-vibrational material.

Similar to other protective members of this disclosure, in some embodiments, the metacarpal protective padding assembly 940 can include multiple discrete protective members individually affixed (stitched, adhered, or otherwise bonded) to the glove body 101. Such discrete protective members may be solid, hollow, air-filled or gas-filled, and/or can include additional material, such as impact resistant material or anti-vibrational material.

The specification and annexed drawings disclose examples of protective gloves. It is, of course, not possible to describe every conceivable combination of elements for purposes of describing the various aspects of the disclosure, but it is noted that many further combinations and permutations of the disclosed elements are possible. Accordingly, various modifications can be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forward in the specification and annexed drawings be regarded, in all respects, in an illustrative rather than in a restrictive sense. Although specific terms are employed in the present disclosure, they are used in a generic and descriptive sense only and not for purposes of limitation.

What is claimed is:

1. A glove configured to protect a hand of a user, comprising:
a flame resistant glove body configured to receive and enclose the hand of the user, the flame resistant glove body including
a palm sleeve,
a thumb sleeve extending distally from the palm sleeve,
a trigger finger sleeve extending distally from the palm sleeve and having a first length; and
a plurality of finger sleeves extending distally from the palm sleeve;
the trigger finger sleeve including
a protective pad assembly extending along a proximal back side of the trigger finger sleeve, the protective pad assembly having a second length that is less than the first length,
a protective member covering a first portion of a side of the trigger finger sleeve and including an indentation adjacent a second portion of the side of the trigger finger sleeve, and
an unprotected distal portion extending from a distal end of the protective pad assembly to a distal end of the trigger finger sleeve, thereby facilitating firing a gun or handling an explosive device while wearing the glove; and
a conductive tab positioned on one of the thumb sleeve, the trigger finger sleeve, or the plurality of finger sleeves to operate a touch screen while wearing the glove.

2. The glove of claim 1, wherein the conductive tab is attached to the trigger finger sleeve.

3. The glove of claim 1, wherein the plurality of finger sleeves includes a middle finger sleeve, and wherein the conductive tab is attached to the middle finger sleeve.

4. The glove of claim 2, wherein the conductive tab is attached to the thumb sleeve.

5. The glove of claim 4, wherein the plurality of finger sleeves includes a middle finger sleeve, and further comprising a second conductive tab attached to the middle finger sleeve, the second conductive tab positioned to operate a touch screen.

6. The glove of claim 5, further comprising respective flame resistant padding assemblies extending along a back side of the palm sleeve, a back side of the thumb sleeve, and a back side of each one of the plurality of finger sleeves, the respective flame resistant padding assemblies sized and positioned to protect the hand of the user.

7. The glove of claim 6, wherein the respective flame resistant padding assemblies comprise a metacarpal elevated padding member having a first section extending between a first peripheral portion and a second peripheral portion of a metacarpal base member, and further having a second section substantially perpendicular to the first section, the metacarpal base member abutting the back side of the palm sleeve.

8. The glove of claim 6, further comprising a gauntlet sleeve depending distally from the palm sleeve, and an elastic wrist band disposed between the palm sleeve and the gauntlet sleeve.

9. The glove of claim 1, wherein the conductive tab comprise polyurethane.

10. The glove of claim 1, wherein the flame resistant glove body comprises aramid fibers.

11. The glove of claim 6, wherein the protective pad assembly and at least a first one of the respective flame resistant padding assemblies comprise thermopoly rubber.

12. The glove of claim 1, wherein the conductive tab is affixed to the one of the thumb sleeve, the trigger finger sleeve, or a plurality of finger sleeves via a seamless construction.

13. The glove of claim 1, wherein the glove is configured for a right hand.

14. The glove of claim 1, wherein the glove is configured for a left hand.

15. The glove of claim 13, wherein the right hand glove is configured for use in firing a gun and operating a touch screen with a right hand.

16. The glove of claim 14, wherein the left hand glove is configured for use in firing a gun and operating a touch screen with a left hand.

17. A glove configured to protect a hand of a user, comprising:
a flame resistant glove body configured to receive and enclose a hand of a user, a palmar side of the flame resistant glove body comprising flame resistant leather, a back side of the flame resistant glove body comprising flame resistant fabric, the flame resistant glove body including
a palm sleeve,
a thumb sleeve extending from the palm sleeve,
a trigger finger sleeve extending from the palm sleeve and having a first length; and
a plurality of finger sleeves extending distally from the palm sleeve;
the trigger finger sleeve including
a protective pad assembly extending along a proximal back side of the trigger finger sleeve, the protective pad assembly having a second length that is less than the first length,
a protective member covering a first portion of a side of the trigger finger sleeve and including an indentation adjacent a second portion of the side of the trigger finger sleeve, and
an unprotected distal portion extending from a distal end of the protective pad to a distal end of the trigger finger sleeve; and
a conductive tab positioned on one of the thumb sleeve, the trigger finger sleeve or the plurality of finger sleeves, the conductive tab affixed over a portion of the flame resistant leather.

18. The glove of claim 17, wherein the conductive tab is attached to the trigger finger sleeve.

19. The glove of claim 17, wherein the plurality of finger sleeves includes a middle finger sleeve, and wherein the conductive tab is attached to the middle finger sleeve.

20. The glove of claim 18, wherein the conductive tab is attached to the thumb sleeve.

21. The glove of claim 20, wherein the plurality of finger sleeves includes a middle finger sleeve, and further comprising a second conductive tab attached to the middle finger sleeve, the second conductive tab positioned to operate a touch screen.

22. The glove of claim 21, further comprising respective flame resistant padding assemblies extending along a back side of the palm sleeve, a back side of the thumb sleeve, and a back side of the plurality of finger sleeves, the respective flame resistant padding assemblies sized and positioned to protect the hand of the user.

23. The glove of claim 22, further comprising a gauntlet sleeve depending distally from the palm sleeve, and an elastic wrist band disposed between the palm sleeve and the gauntlet sleeve.

24. The glove of claim 17, wherein the conductive tab comprises polyurethane.

25. The glove of claim 17, wherein the flame resistant fabric comprises aramid fibers.

26. The glove of claim 21, wherein the protective pad and at least a first one of the respective flame resistant padding assemblies comprise thermopoly rubber.

27. The glove of claim 17, wherein the conductive tab is affixed to the one of the thumb sleeve, the trigger finger sleeve, or a plurality of finger sleeves via a seamless construction.

28. The glove of claim 17, wherein configured for a right hand.

29. The glove of claim 17, wherein configured for a left hand.

30. The glove of claim 28, wherein the right hand glove is configured for use in firing a gun and operating a touch screen with a right hand.

31. The glove of claim 29, wherein the left hand glove is configured for use in firing a gun and operating a touch screen with a left hand.

32. A glove configured to protect a hand, comprising:
a flame resistant glove body configured to receive and enclose a hand of a user, a palmar side of the glove body comprising flame resistant leather, a back side of the glove body comprising flame resistant fabric, the glove body including
a palm sleeve,
a thumb sleeve extending from the palm sleeve,
a trigger finger sleeve extending distally from the palm sleeve and having a first length, and
a plurality of finger sleeves extending distally from the palm sleeve, the plurality of finger sleeves including a middle finger sleeve adjacent to the trigger finger sleeve;
the trigger finger sleeve including
a protective pad assembly extending along a proximal back side of the trigger finger sleeve, the protective pad assembly having a second length that is less than the first length,
a protective member covering a first portion of a side of the trigger finger sleeve and including an indentation adjacent a second portion of the side of the trigger finger sleeve, and
an unprotected distal portion extending from a distal end of the protective pad assembly to a distal end of the trigger finger sleeve; and
a conductive tab affixed to the middle finger sleeve to operate a touch screen while wearing the glove.

33. The glove of claim 32, wherein the conductive tab is affixed to the middle finger sleeve via a seamless construction.

34. The glove of claim 33, wherein the seamless construction includes an inside seam situated on an interior of the glove between a lower end of the conductive tab and the flame resistant leather such that there is no exteriorly exposed seam between conductive tab and the flame resistant leather.

35. The glove of claim 34, wherein an interior side of the conductive tab is underlined with the flame resistant leather for protection of a user.

36. The glove of claim 34, wherein an interior side of the conductive tab is unlined for improved feel through the conductive tab and a fingertip of a user.

37. The glove of claim 32, further comprising respective flame resistant padding assemblies extending along a back side of the palm sleeve, a back side of the thumb sleeve, and respective back sides of the plurality of finger sleeves, the respective flame resistant padding assemblies sized and positioned to protect a hand of a user.

38. The glove of claim 37, further comprising a gauntlet sleeve depending distally from the palm sleeve, and an elastic wrist band disposed between the palm sleeve and the gauntlet sleeve.

39. The glove of claim 32, wherein the conductive tab comprises polyurethane.

40. The glove of claim 32, wherein the flame resistant glove body comprises aramid fibers.

41. The glove of claim 37, wherein the protective pad and a first one of the respective flame resistant padding assemblies comprise thermopoly rubber.

42. The glove of claim 32, further comprising a second conductive tab on the trigger finger sleeve.

43. The glove of claim 32, further comprising a second conductive tab on the thumb sleeve, the second conductive tab positioned for use in operating a touch screen.

44. The glove of claim 32, wherein configured for a right hand.

45. The glove of claim 32, wherein configured for a left hand.

46. The glove of claim 44, wherein the right hand glove is configured for use in firing a gun and operating a touch screen with a right hand.

47. The glove of claim 45, wherein the left hand glove is configured for use in firing a gun and operating a touch screen with a left hand.
